(19) United States
(12) Patent Application Publication
(10) Pub. No.: US 2014/0040636 A1
(43) Pub. Date: Feb. 6, 2014

(54) EMBEDDED CONTROLLER TO VERIFY CRTM

(71) Applicants: Jeff Jeansonne, Houston, TX (US); Monji G Jabori, Houston, TX (US); Vali Ali, Cypress, TX (US)

(72) Inventors: Jeff Jeansonne, Houston, TX (US); Monji G Jabori, Houston, TX (US); Vali Ali, Cypress, TX (US)

(21) Appl. No.: 14/112,569

(22) PCT Filed: Apr. 29, 2011
(86) PCT No.: PCT/US11/34578

§ 371 Date: Oct. 18, 2013

(51) Int. Cl. G06F 21/60

(52) U.S. Cl. CPC G06F 21/602
USPC 713/189

(57) ABSTRACT

In one embodiment a computing system includes an embedded controller to verify the provider of the core root of trust for measurement (CRTM).

### BACKGROUND

Computing systems have basic input/output system (BIOS). The BIOS is a set of software routines that test hardware at startup, starts the operating system and supports the transfer of data among hardware devices. The BIOS routines can be stored on a non-volatile storage such as a read only memory, a programmable read only memory, erasable programmable read only memory, flash memory or another non-volatile memory.

### BRIEF DESCRIPTION OF THE DRAWINGS

Some embodiments of the invention are described with respect to the following figures:

FIG. 1 is a block diagram of a computing system including an embedded controller according to an example embodiment;

FIG. 2 is a block diagram of a computing system including an embedded controller according to an example embodiment;

FIG. 3 is a flow diagram of a method to secure the core root of trust for measurement (CRTM) according to an example embodiment;

FIG. 4 is a flow diagram of a method to secure the core root of trust for measurement (CRTM) according to an example embodiment; and

FIG. 5 is block diagram of a computing system including a computer readable media according to an example embodiment.

### DETAILED DESCRIPTION

A computing system can include a computer readable media that stores the BIOS routines. The computer readable media can include a core root of trust for measurement (CRTM). The CRTM can be stored on an immutable part of computer readable media. The immutable part of the computer readable media cannot be erased or written by the components in the computing system such as the processor. A chain of trust can be created by the CRTM.

The CRTM is boot block code. This piece of code is considered trustworthy. The CRTM is used to measure integrity value of other entities, and should stay unchanged during the lifetime of the platform. CRTM is an extension of normal BIOS, which will be run first to measure other parts of the BIOS block before passing control. The BIOS then measures hardware, and the boot loader and passes control to the boot loader. The boot loader measures an operating system (OS) kernel and passes control to the OS.

The computer readable media that stores the BIOS and CRTM has an immutable portion created by preventing the host processor or other components from erasing or writing to the portion of the computer readable media. For example the immutable portion of the computer readable media may be in an address range that the host processor is prevented from writing to. However if the computer readable media is removed from the computing system, the computer readable media does not contain protections that prevent the immutable portion of the computer readable media from being rewritten by a memory programmer. The computer readable media could also be replaced by another computer readable media with a different code on the immutable address section. If the CRTM is compromised by removing the computer readable media and replacing it the chain of trust is broken and any further measurements of the integrity of the system are not trustworthy.

Verifying the CRTM by a portion of the computing system that does not change is important for establishing a chain of trust. While the host processor may be able to verify the CRTM, the processor firmware is in the BIOS that can't be verified until the CRTM is used to verify the rest of the BIOS routines.

In one embodiment, a computing system can include a non-volatile memory. The non-volatile memory can include a portion that is a core root of trust for measurement (CRTM). An embedded controller in the computing system can verify the provider of the CRTM. The host processor in the computing system can execute the CRTM upon verification of the authenticity to measure other parts of the BIOS code.

In one embodiment, a method of securing the core root of trust for measurement (CRTM) includes reading the CRTM with an embedded controller. The method can hash the CRTM to create a hash value with the embedded controller and decrypt the hash value included with the CRTM using a public key with the embedded controller. It can be determined if the two hashes match in which case, the CRTM is verified to come from a known source that has the associated private key. The loading of the embedded controller code can be stopped if the decrypted hash is an unexpected value.

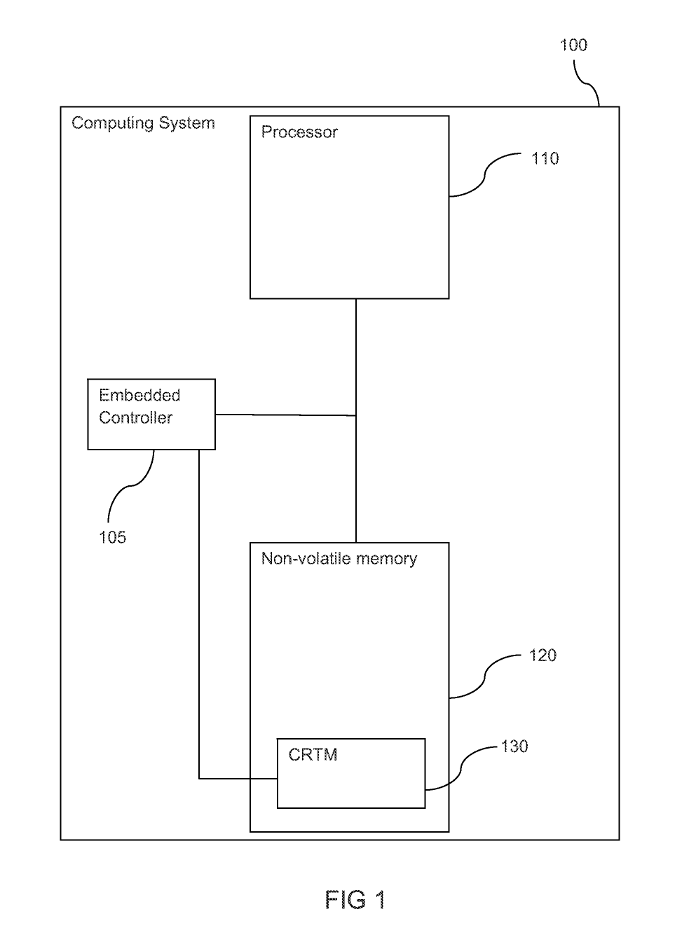

With reference to the figures, FIG. 1 is a block diagram of a computing system including an embedded controller according to an example embodiment. The computing system 100 can include a non-volatile memory 120 including a portion that is a core root of trust for measurement (CRTM) 130. The CRTM is a boot block code that is considered trustworthy. The CRTM 130 is used to measure integrity value of other entities. The CRTM 130 should stay unchanged during the lifetime of the computing system. The CRTM 130 is the first piece of code that executes on a platform at boot. The CRTM 130 should be trusted to properly report to a trusted platform module or another component what is the first software/firmware that executes after the CRTM 130.

An embedded controller 105 can verify the provider of the CRTM 130. The embedded controller 105 may include a keyboard controller to receive key stroke information from a keyboard or cursor movement information from a mouse, a thermal controller to measure temperature or control fans, or combinations for example. The provider of the CRTM may be for example, the manufacturer of the computing system. Verifying the provider of the CRTM may be by a digital signature, CRC, check sum or another verification method for example. A digital signature may be used to identify who produced a file or document or to detect and track any changes that have been made to the document. A digital signature may use a hash function and cryptographic keys. By determining with the embedded controller if the CRTM was from a specific provider a third party may not be able to remove the non-volatile memory 120 from the computing system 100 and replace or reprogram the memory with a CRTM code that was not signed by the provider and then boot the computing system with the replacement or reprogrammed memory.

The computing system includes a processor 110 to execute the CRTM upon verification of the authenticity. The execution of the CRTM measures other parts of the BIOS code. The CRTM can hand off the boot process to the BIOS code after the BIOS has been measured. The BIOS can measure the boot loader of the operating system (OS) and the boot loader can measure the OS. A boot loader is code that begins the booting process for a component or system and may include or be firmware. The OS may be the end of the chain that started with the embedded controller verifying the CRTM.

The CRTM 130 can be an immutable boot block. An immutable boot block cannot be written or erased by an application outside of the immutable boot block of the computing system 100. For example the processor and the embedded controller are able to write to the CRTM if what is being written to the CRTM is a result of the execution of code that is part of the CRTM already so that unknown code does not write to the CRTM.

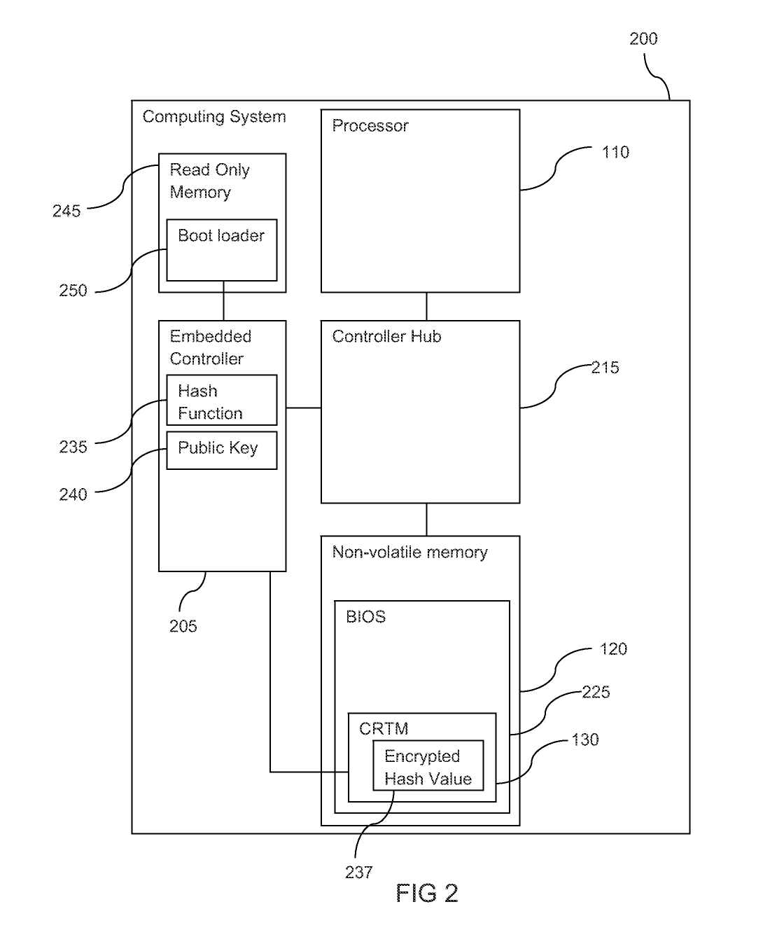

FIG. 2 is a block diagram of a computing system including an embedded controller according to an example embodiment. The computing system 200 may include a hash function 235 executed by the embedded controller to determine a hashed value from the CRTM. The embedded controller 205 may access the CRTM and read data based on the hash function 235.

The embedded controller may include a read only memory 245. The read only memory 245 may include a boot loader 250 for the embedded controller. The embedded controller 205 may provide digital signature verification of the CRTM. The read only memory may also include the hash function 235. The read only memory 245 may be on board the embedded controller. The embedded controller may not be altered such as by reprogramming. For example the read only memory 245 may be in the same package, on the same substrate, or connected to the embedded controller. The embedded controller may include a cryptographic key in the read only memory 245. The cryptographic key can be for decryption of asymmetric data or symmetric data. The decryption key may be a public key on the embedded controller 205 to decrypt the encrypted hash value 237 from the CRTM 130. The decrypted data can be compared to data generated by the embedded controller from the hash function 235 applied to the CTRM 130 of the basic input output system (BIOS) 225. The comparison can result in the CRTM 130 being verified that it is from the provider or it is not from the provider. If the CRTM is from the provider then the boot process continues and the CRTM measures the BIOS. The processor 110 may access the BIOS 225 after the provider of the CRTM is verified and through the controller hub 215.

The embedded controller may refuse to load the embedded controller code. The embedded controller may operate based on a boot loader in a read only memory. A boot loader can be firmware that determines the operation of the embedded controller. Providing the read only boot loader prevents the embedded controller firmware from being changed allowing the embedded controller to reliably determine the provider of the CRTM.

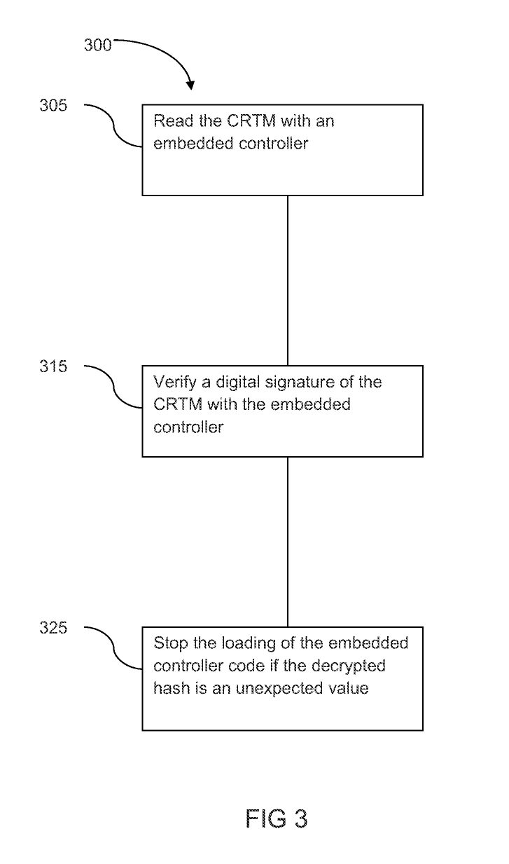

FIG. 3 is a flow diagram of a method to secure the core root of trust for measurement (CRTM) according to an example embodiment. The method 300 of securing the core root of trust for measurement (CRTM) includes reading the CRTM with an embedded controller at 305. The embedded controller can verify the digital signature of the CRTM at 315. In one embodiment, verifying the digital signature can include calculating a hash value by applying a hash function to data read from the CRTM.

An encrypted hash value for the CRTM can be read from the CRTM and be decrypted with the embedded controller. The encrypted stored hash value can be decrypted by applying a key to decrypt the hash value. The key may be a key for symmetric encryption or an asymmetric encryption such as a public and private key encryption technique.

The embedded controller can determine if the decrypted hash value matches the calculated hash value. If the decrypted hash value is an expected hash value then the CRTM was from a known provider. The expected hash value can be determined by comparing the decrypted hash value to a value of the hash of the CRTM as calculated by the embedded controller. A match implies that the CRTM was provided by the known provider.

If the decrypted hash value is not an expected value then the provider of the CRTM cannot be authenticated and the root of the chain of trust can therefore not be established as trustworthy. This may occur if the non-volatile memory storing the CRTM is removed and replaced or reprogrammed outside of the computing system or if the non-volatile memory is damaged causing a corruption of the data on the non-volatile memory. If the decrypted hash value is not an expected value then the embedded controller stops loading the firmware code for the embedded controller at 325. If the firmware for the embedded controller does not load then the computing system does not does not measure the BIOS with the CRTM and control is not passed to the BIOS preventing the computing system from completely booting the operating system.

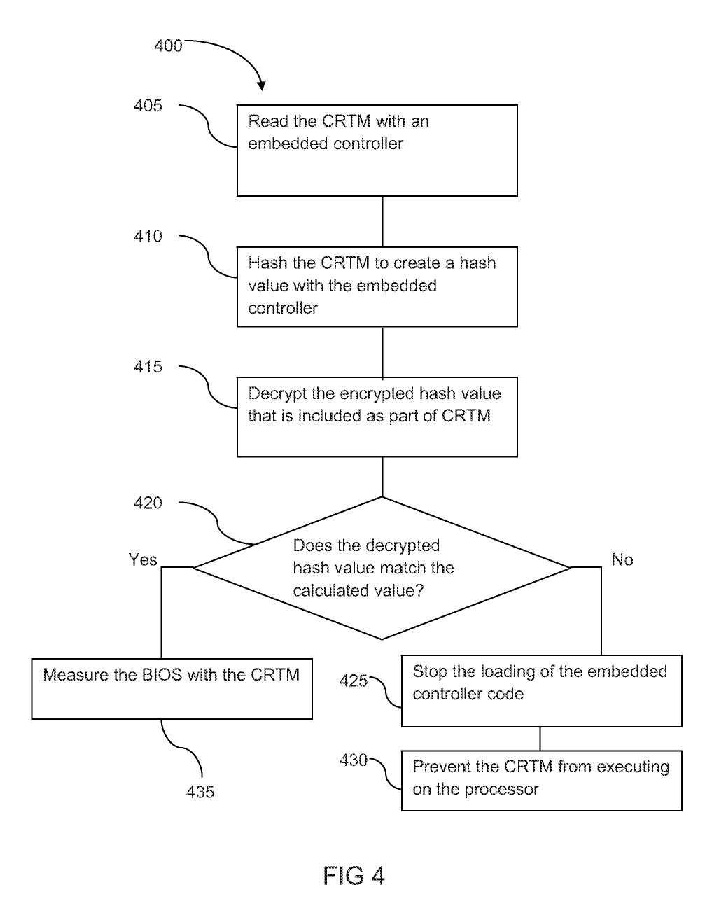

FIG. 4 is a flow diagram of a method to secure the core root of trust for measurement (CRTM) according to an example embodiment. The method 400 of includes reading the CRTM with the embedded controller at 405. The embedded controller can hash the CRTM to create a calculated hash value at 410. The encrypted hash value can be decrypted at 415. A determination can be made at 420 to determine if the calculated hash value is an expected value such as the decrypted hash value.

If the hash value is an expected value then the BIOS is measured with the CRTM at 435 to continue the chain of trust. The CRTM may be executed by the processor to determine if the BIOS is trustworthy. In one embodiment the measurement of the BIOS by the CRTM uses a trusted platform module to store measurements and can optionally store secrets (keys) that will only be released by the TPM upon subsequent boot if the measurements are identical. These keys could be used for sealed storage for example.

If the hash is not an expected value the embedded controller stops loading firmware code at 425. The CRTM can be prevented from executing on the host processor at 430 if it is determined that the hash value is an unexpected value. If the CRTM cannot be used to establish that the BIOS is trustworthy then the system will not continue booting.

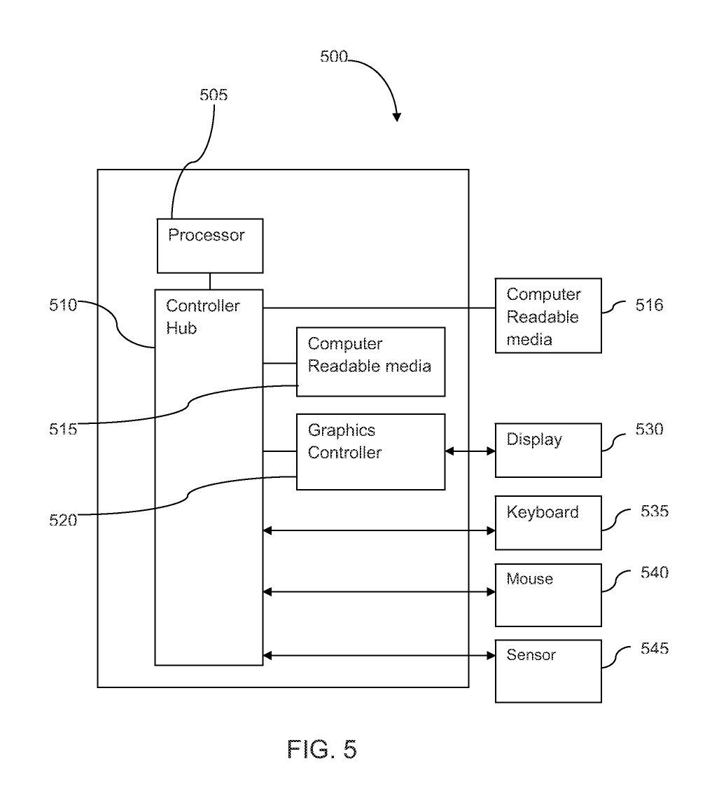

FIG. 5 is block diagram of a computing system 500 including a computer readable medium 515 or 516 according to an example embodiment. The computer readable medium 515 or 516 can include code that if executed causes an embedded controller to read the CRTM of a BIOS on a storage. The code can cause the embedded controller to hash the CRTM and to decrypt an encrypted stored hash in the CRTM. The code can cause the embedded controller from continuing to load code from the boot loader ROM of the embedded controller.

The computer readable medium 515 or 516 may include code that if executed causes an embedded controller to prevent a processor from measuring a BIOS code with the CRTM.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A computing system comprising:
a non-volatile memory including a portion that is a core root of trust for measurement (CRTM);
an embedded controller to verify the provider of the CRTM; and
a host processor to execute the CRTM upon verification of the authenticity to measure other parts of the BIOS code.

2. The system of claim 1, wherein the CRTM is an immutable boot block.

3. The system of claim 1, further comprising a read only memory for boot code on board the embedded controller executed by the embedded controller during boot.

4. The system of claim 1, wherein the embedded controller is not a programmable.

5. The system of claim 1, further comprising a hash function executed by the embedded controller to determine a hashed value from the CRTM.

6. The system of claim 5, further comprising a public key stored on the embedded controller to decrypt the hashed value.

7. The system of claim 6, wherein the embedded controller refuses to load the embedded controller code.

8. There system of claim 7, further comprising an embedded controller boot loader in read only memory.

9. A method of securing the core root of trust for measurement (CRTM) on a computing system comprising:
reading the CRTM with an embedded controller;
verifying a digital signature of the CRTM with the embedded controller; and
stopping the loading of the embedded controller code if the decrypted hash does not match the calculated hash

10. The method of claim 9, further comprising preventing the CRTM from executing on a processor if the digital signature verification of the CRTM fails.

11. The method of claim 9, further comprising measuring a portion of the BIOS with the CRTM if the digital signature of the CRTM is verified.

12. A computer readable medium comprising code that if executed causes an embedded controller to:
read the CRTM of a BIOS on a storage;
calculate the hash of the CRTM;
decrypt the encrypted hash of the CRTM included with that CRTM;
compared the decrypted hash as the calculated hash; and
stop loading code from the boot loader ROM of the embedded controller if the hashes are not equal.

13. The computer readable medium of claim 12 further comprising code that if executed causes an embedded controller to:
prevent a processor from measuring a BIOS code with the CRTM.
